(19) United States
(12) Patent Application Publication
(10) Pub. No.: US 2015/0136668 A1
(43) Pub. Date: May 21, 2015

(54) Oil Separating Apparatus

(71) Applicant: Chin-Lun Chang, Yuanlin Township (TW)

(72) Inventor: Chin-Lun Chang, Yuanlin Township (TW)

(21) Appl. No.: 14/540,229

(22) Filed: Nov. 13, 2014

(30) Foreign Application Priority Data
Nov. 21, 2013 (CN) 201320744131.1

(51) Int. Cl. C02F 1/40

(52) U.S. Cl. CPC C02F 1/40; C02F 2201/002; C02F 2103/34
USPC 210/110; 210/252

(57) ABSTRACT

An oil separating apparatus includes a preliminary separator and a main separator. The preliminary separator is for collecting wastewater. The main separator has a main separating chamber, a wastewater exit channel and a communicating channel. The main separating chamber communicates with the preliminary separator, and has upper and lower openings. The communicating channel communicates the wastewater exit channel and the lower opening. A distance between the upper and lower openings ranges from 300 millimeters to 3000 millimeters.

### CROSS-REFERENCE TO RELATED APPLICATION

This application claims priority of Chinese Application No. 201320744131.1, filed on Nov. 21, 2013.

### FIELD OF THE INVENTION

The invention relates to a recycling equipment, more particularly to an oil separating apparatus.

### BACKGROUND OF THE INVENTION

Taiwanese Utility Model Patent No. M415739 discloses a conventional oil separating apparatus for separating wastewater. The conventional oil separating apparatus includes a first tank that is filled with wastewater, a second tank, and a drawing unit that draws the wastewater from the first tank and pours the wastewater into the second tank.

The wastewater in first tank is preliminarily separated into an oil layer and a water layer due to the difference in specific gravity. The drawing unit includes a floating plate that is located at the interface of the oil and water layers, and that has a suction inlet, a drawing tube that interconnects the floating plate and the second tank, and a rotary pump that is connected to the drawing tube for driving a wastewater to flow from the first tank into the second tank via the drawing tube.

The second tank has a casing defining a separating space therein, a plurality of spaced-apart upright plates disposed in the separating space, an oil outlet formed at an upper portion of the casing, and a water outlet formed at a lower portion of the casing.

The conventional oil separating apparatus has the following drawbacks.

1. Rotors and a housing of the rotary pump must be sealed tightly with each other for generating a suction force. Therefore, the rotary pump may easily be blocked by particles in the wastewater.

2. The particles in the wastewater may cause abrasion of the rotors and an inner surface of the housing of the rotary pump.

3. When the wastewater is configured to be saponified, the suction inlet of the floating plate may be obstructed to prevent the rotary pump from drawing the wastewater, and may cause superheat and breakdown of the rotary pump.

4. During the separating process of the second tank, water may easily exit the separating space via the oil outlet due to the configuration of the second tank.

### SUMMARY OF THE INVENTION

Therefore, the object of the present invention is to provide an oil separating apparatus that can overcome at least one of the aforesaid drawbacks associated with the prior arts.

Accordingly, an oil separating apparatus of the present invention includes a preliminary separator and a main separator. The preliminary separator is for collecting wastewater. The main separator has a main separating chamber, a wastewater exit channel and a communicating channel. The main separating chamber communicates fluidly the preliminary separator, and has an upper opening and a lower opening. The communicating channel communicates fluidly the wastewater exit channel and the lower opening of the main separating chamber. A distance between the upper and lower openings of the main separating chamber ranges from 300 millimeters to 3000 millimeters.

### BRIEF DESCRIPTION OF THE DRAWINGS

Other features and advantages of the present invention will become apparent in the following detailed description of the embodiments with reference to the accompanying drawings, of which:

FIG. 1 is a fragmentary sectional view of a first embodiment of an oil separating apparatus according to the invention;

FIG. 2 is a fragmentary sectional view of a preliminary separator of the first embodiment;

FIG. 3 is a fragmentary sectional view of a main separator and an auxiliary separator of the first embodiment;

FIG. 4 is a top view of the main separator;

FIG. 5 is a top view of the auxiliary separator;

FIG. 6 is a fragmentary sectional view of a preliminary separator of a second embodiment of the oil separating apparatus according to the invention;

FIG. 7 is a fragmentary sectional view of a preliminary separator of a third embodiment of the oil separating apparatus according to the invention;

FIG. 8 is a fragmentary sectional view of a preliminary separator of a fourth embodiment of the oil separating apparatus according to the invention;

FIG. 9 is another fragmentary sectional view of the preliminary separator of the fourth embodiment, illustrating a barrier is adjusted in height;

FIG. 10 is a fragmentary sectional view of a preliminary separator of a fifth embodiment of the oil separating apparatus according to the invention; and

FIG. 11 is a fragmentary sectional view of a main separator of a sixth embodiment of the oil separating apparatus according to the invention.

### DETAILED DESCRIPTION OF THE EMBODIMENTS

Before the present invention is described in greater detail, it should be noted that like elements are denoted by the same reference numerals throughout the disclosure.

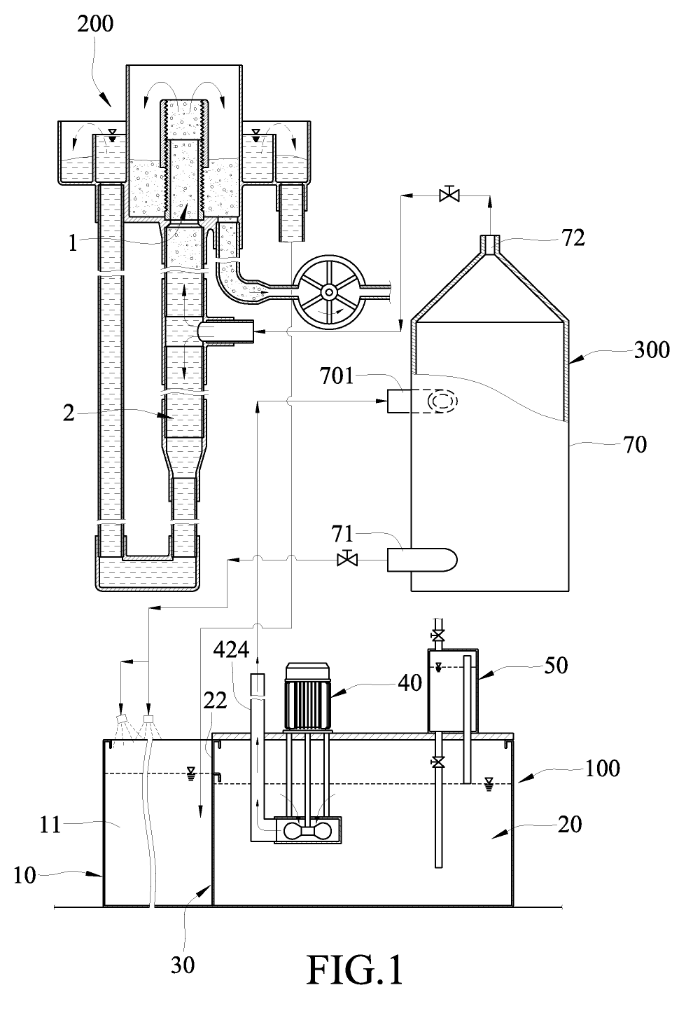

As shown in FIG. 1, a first embodiment of an oil separating apparatus according to the present invention includes a preliminary separator 100, a main separator 200 and an auxiliary separator 300.

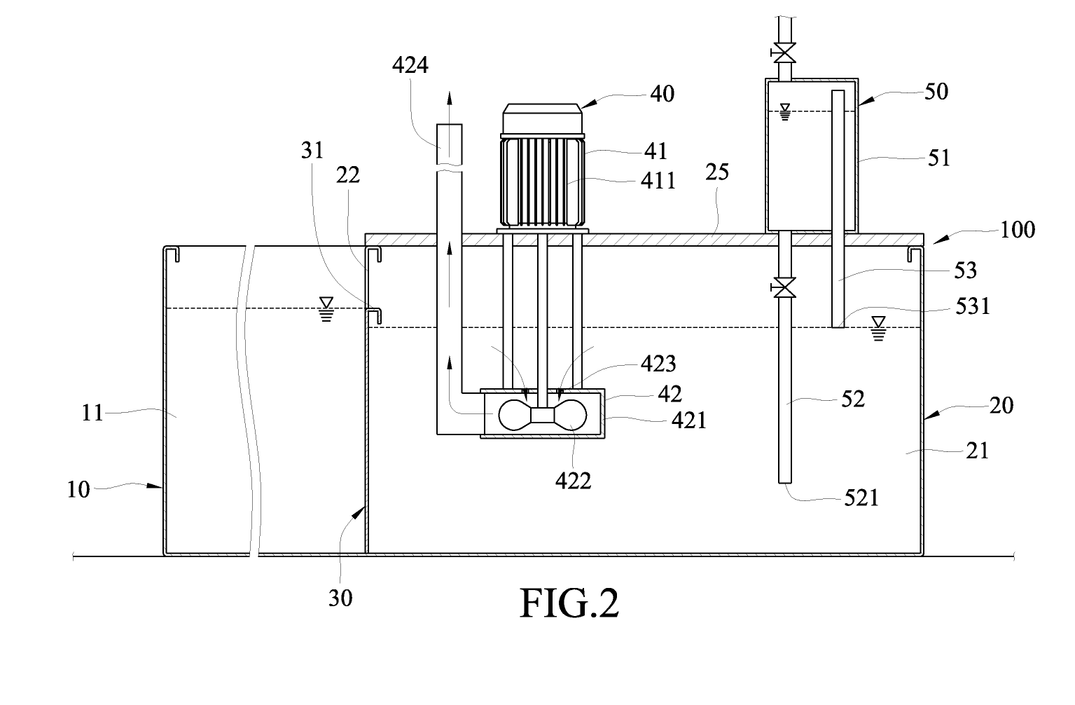

Referring to FIG. 2 the preliminary separator 100 includes a first tank 10, a second tank 20, a barrier 30, a drawing unit 40 and a liquid-level control unit 50.

The first tank 10 defines a first space 11 therein that is opened upwardly for being filled with wastewater.

The second tank 20 defines a second space 21 therein that is opened upwardly, and includes a mounting frame 25 that is disposed above the second space 21. In this embodiment, the first and second tanks 10, 20 are formed into one piece.

The barrier 30 is configured as a plate, and spaces the first and second spaces 11, 21. An upper edge 31 of the barrier 30 cooperates with the first and second tanks 10, 20 to define an overflow channel 22. When the liquid level of the wastewater in the first space 11 is higher than the upper edge 31 of the barrier 30, the wastewater flows over the upper edge 31 of the barrier 30 and into the second space 21.

The drawing unit 40 includes a driving device 41 and drawing device 42. The driving device 41 includes a motor 411 mounted to the mounting frame 25 of the second tank 20. The drawing device 42 includes a housing 421, a vane wheel 422, a suction inlet 423 and a drain conduit 424. The housing 421 is disposed in the second space 21. The vane wheel 422 is disposed in the housing 421 and is driven by the motor 411. The suction inlet 423 is formed in an upper portion of the housing 421 and lower than the upper edge 31 of the barrier 30. The drain conduit 424 is connected to the housing 421, and extends out of the second space 21 for draining the wastewater out from the second space 21.

The liquid-level control unit 50 includes a liquid container 51, a liquid tube 52 and a control tube 53. The liquid container 51 is disposed above the second tank 20, and contains a liquid. The liquid tube 52 communicates fluidly the second space 21 and the liquid in an inner space of the liquid container 51, and has an end opening 521 distal from the liquid container 51. The control tube 53 communicates fluidly the second space 21 and a portion of the inner space of the liquid container 51 located above the liquid, and has an end opening 531 distal from the liquid container 51. The end opening 531 of the control tube 53 is higher than the suction inlet 423 and the end opening 521 of the liquid tube 52, and lower than the upper edge 31 of the barrier 30. The liquid in the liquid container 51 flows into the second space 21 when the liquid level of the wastewater in the second space 21 is lower than the end opening 531 of the control tube 53.

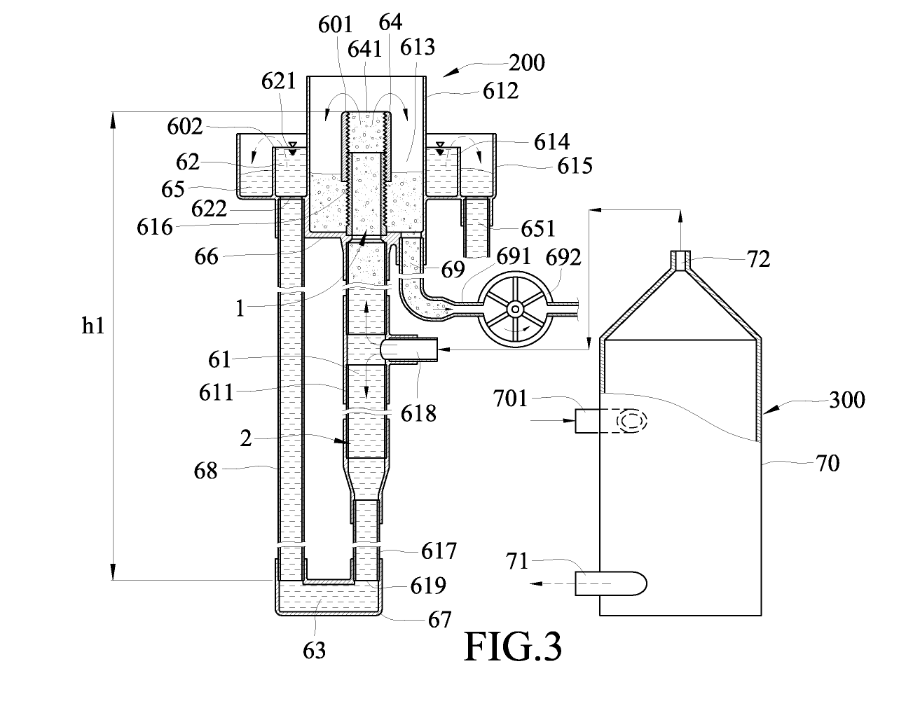

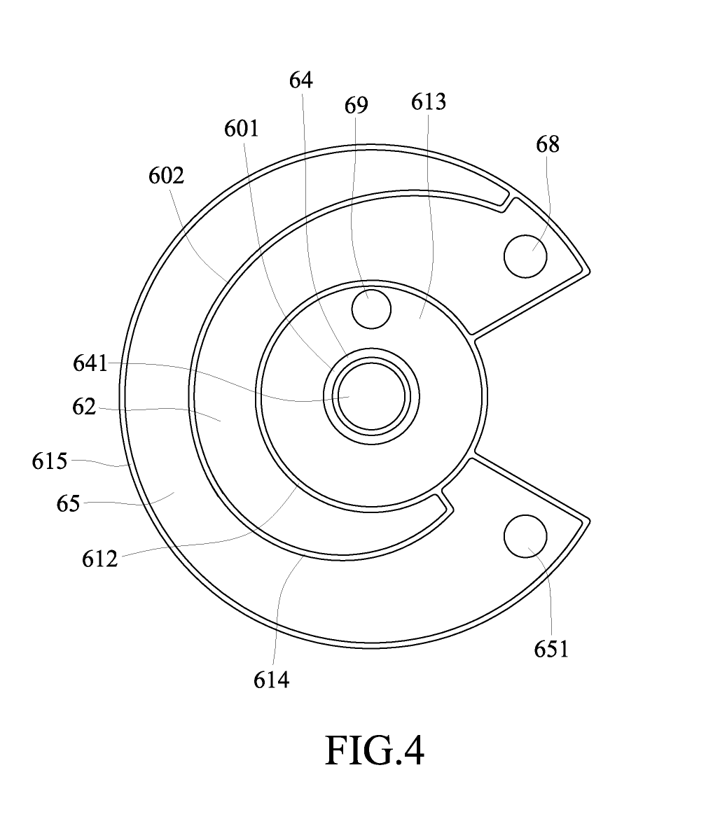

Referring to FIGS. 3 and 4, the main separator 200 includes an upright main tube 611, an upper body 66, a lower body 67, an extending tube 68 and an oil exit tube 69.

The main tube 611 includes a main tube portion and a sleeve member 64 that is threaded drivingly on an upper portion 616 of the main tube portion. The sleeve member 64 and the main tube portion cooperatively define a main separating chamber 61 therein. An upper portion of the sleeve member 64 defines an upper opening 641 of the main separating chamber 61, and serves as a first weir 601. The main tube portion has a lower portion 617 defining a lower opening 619 of the main separating chamber 61. A distance (h1) between the upper and lower openings 641, 619 of the main separating chamber 61 ranges from 300 millimeters to 3000 millimeters. The main tube 611 further has an inlet tube portion 618 that is located between the upper and lower openings 641, 619 of the main separating chamber 61, and that communicates fluidly with the main separating chamber 61.

The upper body 66 is connected to an upper portion of the main tube 611, and includes a surrounding wall 612, a first wall segment 614 and a second wall segment 615.

The surrounding wall 612 surrounds the sleeve member 64 and the upper portion 616 of the main tube portion, and cooperates with the sleeve member 64 and the upper portion 616 of the main tube portion to define an oil chamber 613 therebetween.

The first wall segment 614 extends around the surrounding wall 612, and cooperates with the surrounding wall 612 to define a wastewater chamber 62 therebetween. The first wall segment 614 extends in a circumferential direction by an angle of more than 180 degrees such that the wastewater chamber 62 extends in the circumferential direction by an angle of more than 180 degrees. The first wall segment 614 has an upper portion that defines an upper opening 621 of the wastewater chamber 62 and that serves as a second weir 602. The upper opening 621 of the wastewater chamber 62 is lower than the upper opening 641 of the main separating chamber 61.

The second wall segment 615 extends around the first wall segment 614, and cooperates with the first wall segment 614 to define a drain chamber 65 therebetween. The second wall segment 615 extends in the circumferential direction by an angle of more than 180 degrees, and the drain chamber 65 extends in the circumferential direction by an angle of more than 180 degrees.

The lower body 67 defines a communicating channel 63 therein that communicates fluidly with the lower opening 619 of the main separating chamber 61.

The extending tube 68 is parallel to the main tube 611, and has opposite ends connected respectively to the upper and lower bodies 66, 67. The extending tube 68 communicates fluidly with the communicating channel 63 and a lower opening 622 of the wastewater chamber 62.

The oil exit tube 69 includes a tube portion 691 that communicates fluidly with the oil chamber 613, and a vane pump 692 that is connected to the tube portion 691 for sealing tightly the tube portion 691 when the oil separating apparatus is not at work.

The main separator 200 further has a wastewater exit channel 651 that communicates fluidly with the drain chamber 65.

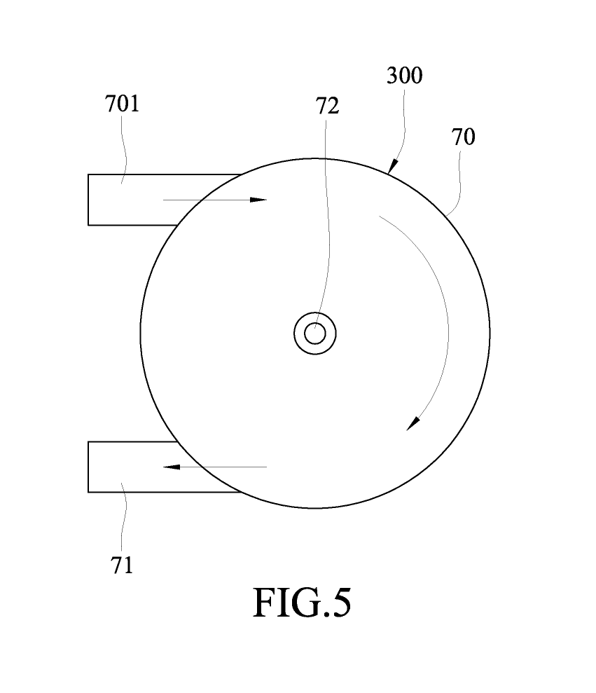

The auxiliary separator 300 includes a barrel 70, a lower outlet tube 71 and an upper outlet tube 72. The barrel 70 defines a separating space therein, and has an inlet opening 701 via which the drain conduit 424 of the drawing device 42 communicates fluidly the separating space. The lower outlet tube 71 is connected to a lower end portion of the barrel 70. The upper outlet tube 72 is connected to an upper end portion of the barrel 70, and communicates fluidly the inlet tube portion 618 of the main separator 200 and the separating space. The inlet opening 701 is located between the lower and upper outlet tubes 71, 72. The flow rate of the inlet opening 701 is greater than that of the lower outlet tube 71. Referring to FIG. 5, the inlet opening 701 and the lower outlet tube 71 are configured so as to create a vortex in the separating space of the barrel 70.

Referring back to FIGS. 1 and 2, wastewater is continuously poured into the first space 11 to be preliminarily separated. When the liquid level of the wastewater in the first space 11 is higher than the upper edge 31 of the barrier 30, an upper layer of the wastewater that has a smaller specific gravity flows over the barrier 30 and into the second space 21. When the liquid level of the wastewater in the second space 21 is higher than the section inlet 423, the motor 411 of the drawing unit 40 is turned on to drive rotation of the vane wheel 422, so as to convey the wastewater from the second space 21 into the barrel 70 of the auxiliary separator 300 via the section inlet 423, the housing 421, the drain conduit 424 and the inlet opening 701.

Referring further to FIG. 3, after entering the barrel 70 of the auxiliary separator 300, a major portion of the wastewater flows back to the first space 11 through the lower outlet tube 71 to be separated, and a minor portion of the wastewater that has a smaller specific gravity flows into the main separating chamber 61 of the main separator 200 via the upper outlet tube 72 and the inlet tube portion 618.

The wastewater in the main separating chamber 61 is separated into an oil layer 1 and a water layer 2 that is located below the oil layer 1. As indicated by the solid arrows in FIGS. 1 and 3, the oil flows over the first weir 601 and into the oil chamber 613, and is expelled from the main separator 200 via the oil exit tube 69 by the vane pump 692. The water in the water layer 2 flows through the communicating channel 63, the extending tube 68 and the wastewater chamber 62, then flows over the second weir 602 and into the drain chamber 65 (indicated by the dotted arrows in FIGS. 1 and 3), and is finally expelled from the main separator 200 via the wastewater exit channel 651. As shown in FIG. 1, the water expelled from the main separator 200 may be guided to flow back to the first space 11.

Due to the difference in specific gravity between water and oil (1:0.95), a distance between the second weir 602 and a bottom end of the oil layer 1 equals to 95 percent of that between the first weir 601 and the bottom end of the oil layer 1. Since the distance (h1) between the upper and lower openings 641, 619 of the main separating chamber 61 ranges from 300 millimeters to 3000 millimeters, the oil layer 1 may have a greater thickness to enhance the effect of the oil separating operation.

Moreover, since water has a specific gravity greater than that of oil, and since the second weir 602 is located below the first weir 601, water cannot flow into the oil chamber 613 via the upper opening 641 of the main separating chamber 61, such that the effect of the oil separating operation is enhanced.

During the above mentioned operation, when the liquid level of the wastewater in the second space 21 is lower than the end opening 531 of the control tube 53 of the liquid-level control unit 50, air can enter the liquid container 51 via the end opening 531. Therefore, the liquid in the liquid container 51 flows into the second space 21 via the liquid tube 52 until the liquid level of the wastewater in the second space 21 rises to block the end opening 531. As a result, the liquid level of the wastewater in the second space 21 is guaranteed to be higher than the suction inlet 423, so as to ensure the drawing unit 40 to work.

As shown in FIG. 1, the wastewater expelled from the auxiliary separator 300 via the lower outlet tube 71 may be poured into the first space 11 at a location distal from the barrier 30. As such, the upper layer of the wastewater that contains more oil is pushed toward the barrier 30 to enhance the effect of the oil separating operation. Moreover, the wastewater is sufficiently exposed to air during the aforesaid circulation process to reduce generation of bad smell.

To sum up, the oil separating apparatus has the following advantages.

1. By virtue of the first space 11, the barrier 30 and the second space 21, the wastewater is preliminarily separated to facilitate the drawing operation performed by the drawing unit 40.

2. By virtue of the liquid-level control unit 50, the liquid level of the wastewater in the second space 21 is guaranteed to be higher than the suction inlet 423, so as to ensure the drawing operation.

3. The motor 411 of the drawing unit 40 is mounted to the mounting frame 25 of the second tank 20 so as to be easily maintained. The housing 421 and the vane wheel 422 of the drawing device 42 have a gap therebetween to permit passing of a particle that has a dimension smaller than 10 millimeters, so as to prevent malfunction of the drawing unit 40 due to the presence of impurities in the wastewater.

4. The vane wheel 422 is driven by the motor 411 to rotate in the housing 421, such that the drawing unit 40 is prevented from breakdown resulting from being obstructed even though the wastewater is configured to be saponified.

5. Since the distance (h1) between the upper and lower openings 641, 619 of the main separating chamber 61 ranges from 300 millimeters to 3000 millimeters, the oil layer 1 may have a greater thickness to enhance the effect of the oil separating operation.

6. If an inner space of the main separator 200 is sealed up, the pressure of the inner space is greater than ambient pressure, such that the wastewater expelled from the wastewater exit channel 651 can be ejected onto workpieces and cutting tools to serve as cutting fluid.

7. If an inner space of the main separator 200 is sealed up, the vane pump 692 is in a sealed state to maintain the pressure in the main separator 200 when the oil separating apparatus is not at work.

8. The wastewater chamber 62 extends in the circumferential direction by an angle of more than 180 degrees, the upper portion of first wall segment 614 that serves as the second weir 602 extends in the circumferential direction by an angle of more than 180 degrees, and the drain chamber 65 extends in the circumferential direction by an angle of more than 180 degrees, such that the oil separating process is stabilized.

It is noted that the liquid-level control unit 50 may be omitted, and that the first tank 10 may be disposed under a CNC machine tool to collect the cutting fluid or other industrial wastewater directly.

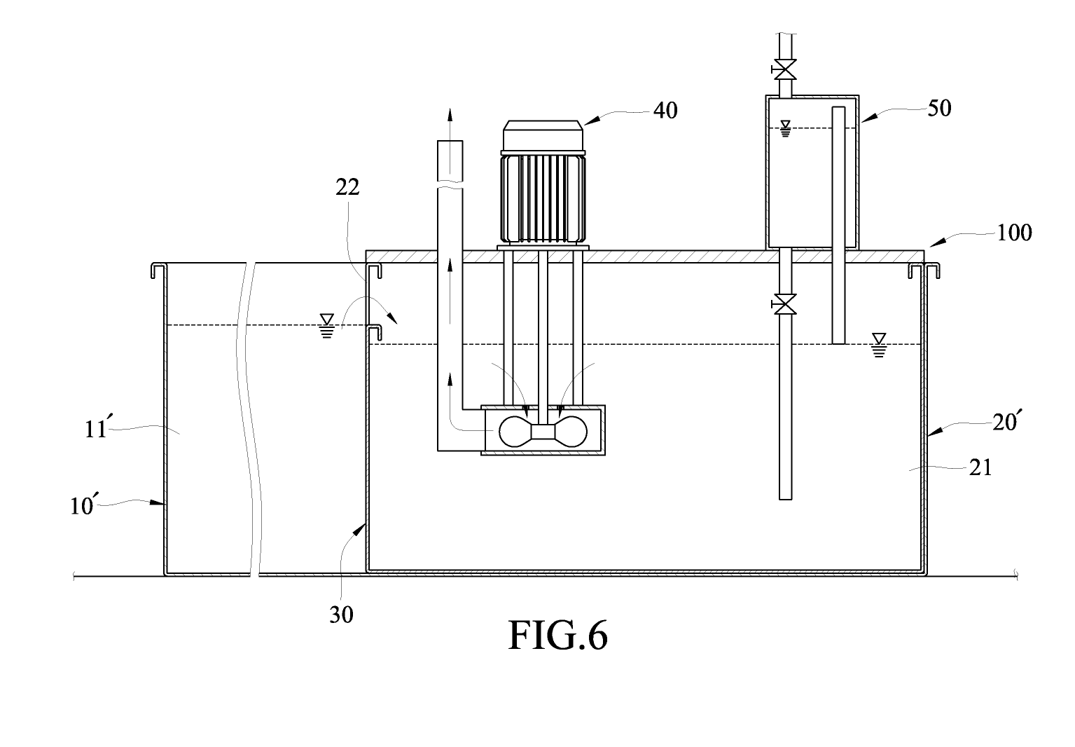

Referring to FIG. 6, the preliminary separator 100 of a second embodiment of the oil separating apparatus according to the present invention is similar to the first embodiment. In the second embodiment, the second tank 20′ is assembled detachably in the first tank 10′, and the first space 11′ is defined between the first and second tanks 10′, 20′.

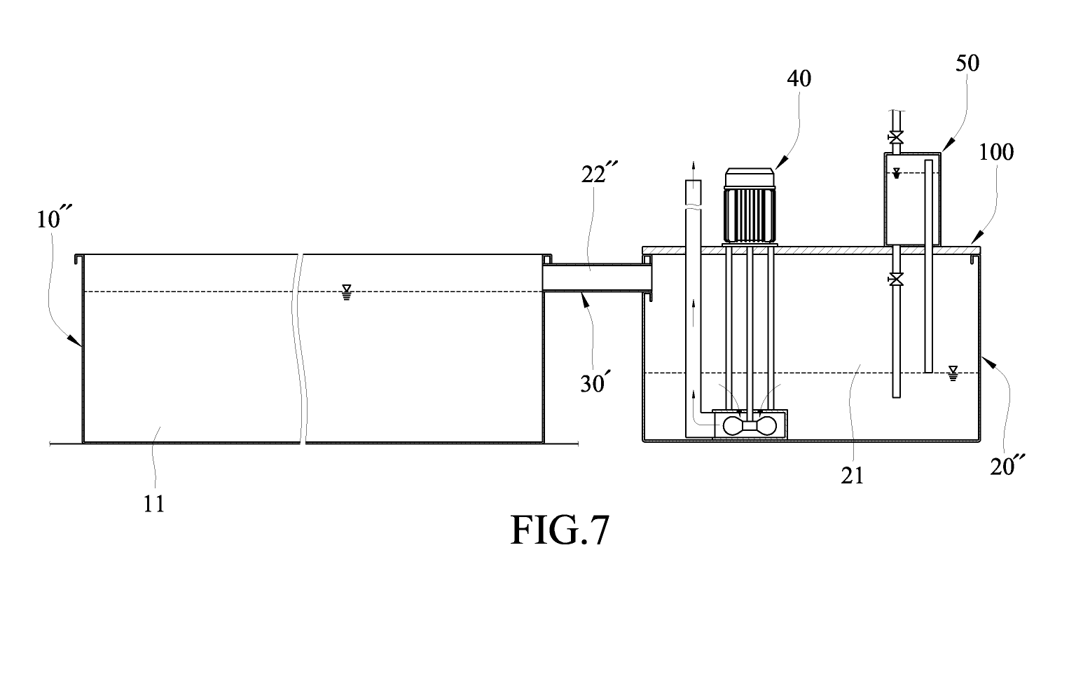

Referring to FIG. 7, the preliminary separator 100 of a third embodiment of the oil separating apparatus according to the present invention includes spaced-apart first and second tanks 10″, 20″ that are interconnected by a communicating tube 22″. A side portion of the first tank 10″, a bottom portion of the communicating tube 22″ and aside portion of the second tank 20″ cooperatively serve as the barrier 30′

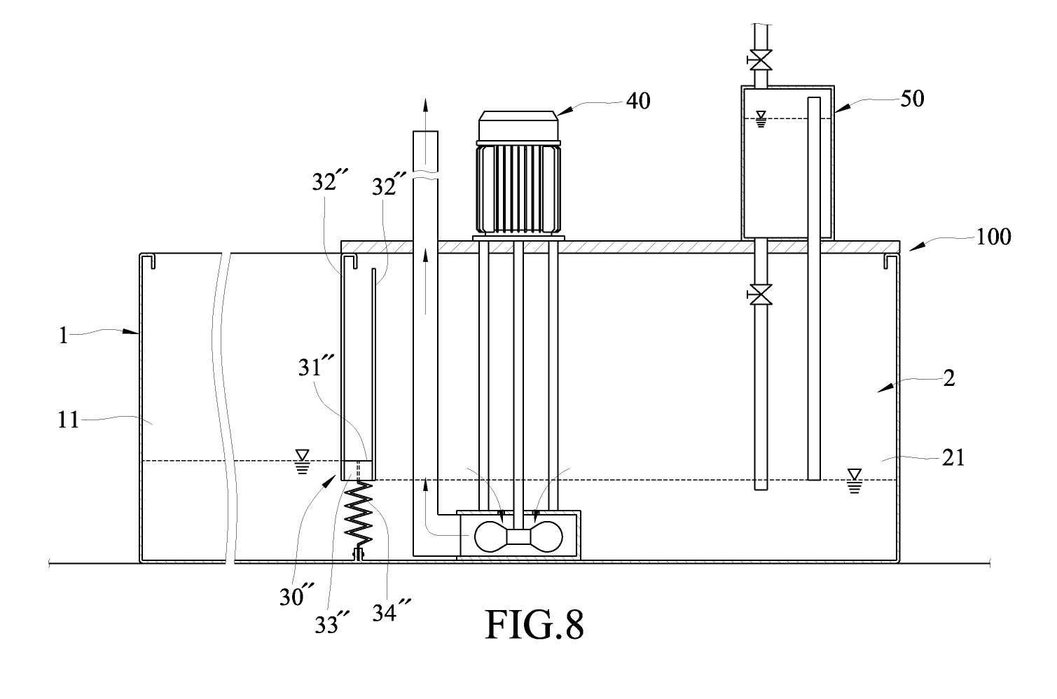

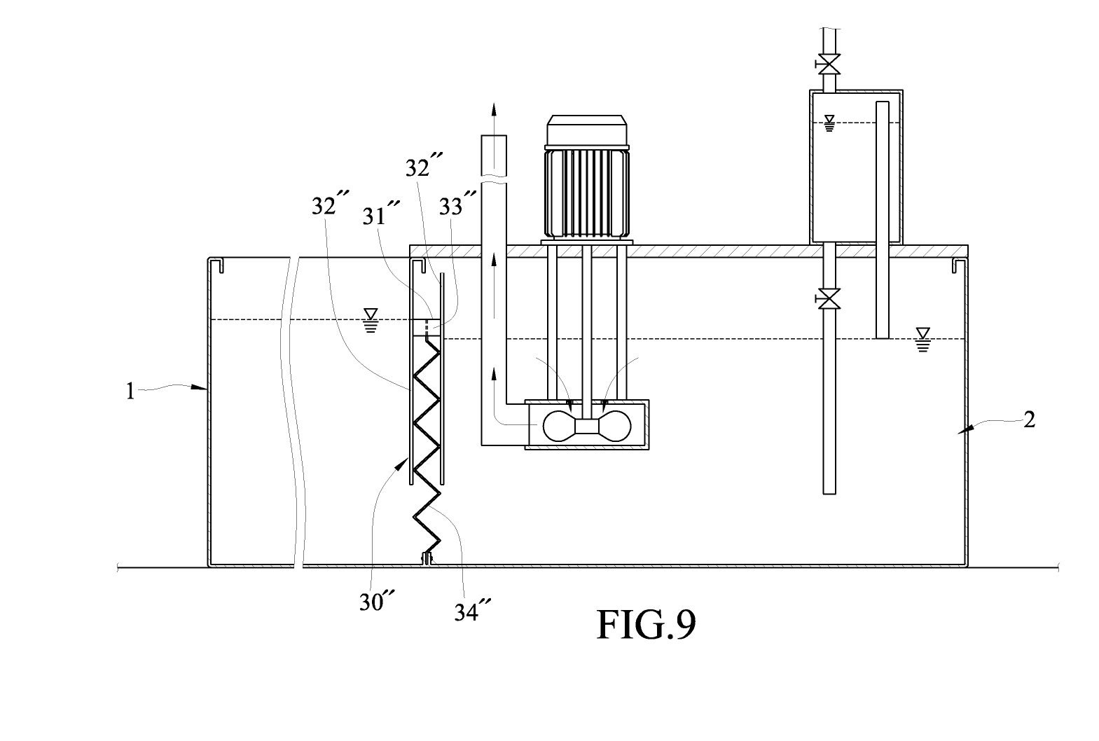

Referring to FIGS. 8 and 9, the preliminary separator 100 of a fourth embodiment of the oil separating apparatus according to the present invention includes first and second tanks 1, 2 that are connected directly to each other, and a barrier 30″ that spaces the first and second spaces 11, 21, and that is adjustable in height. The barrier 30″ includes a pair of spaced-apart vertical guide rails 32″, a sliding block 33″ that is disposed between and in contact with the guide rails 32″, and that is slidable along the guide rails 32″, and a telescopic plate assembly 34″ that is connected to the sliding block 33″ and for spacing the first and second spaces 11, 21. In this embodiment, an upper portion of the sliding block 33″ serves as the upper edge 31″ of the barrier 30″, and the telescopic plate assembly 34″ is configured as a pleated plate. The upper edge 31″ of the barrier 30″ is adjustable in height according to different demands (see FIG. 9).

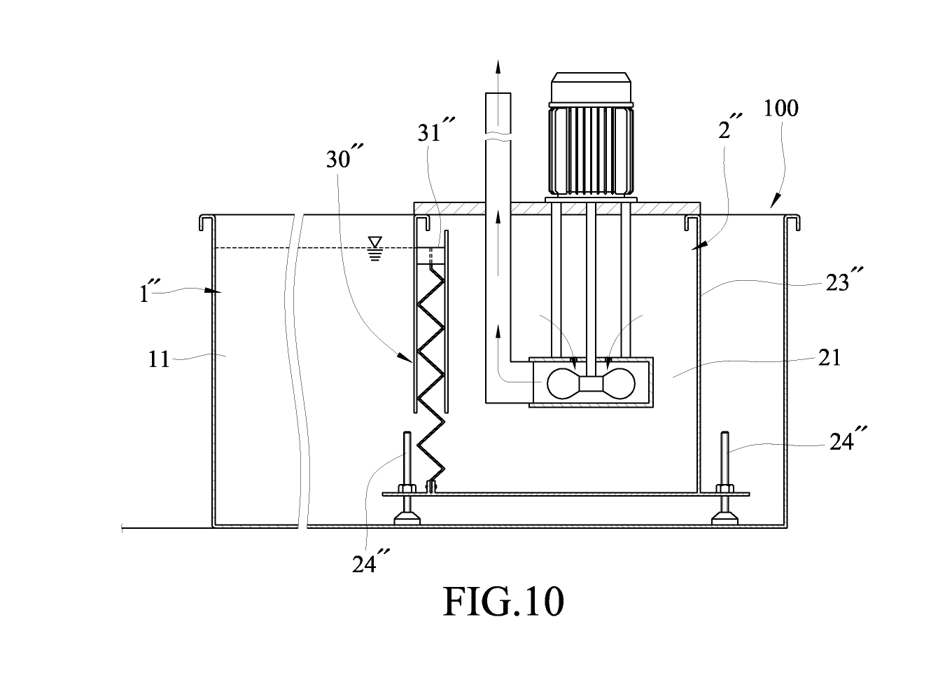

Referring to FIG. 10, the preliminary separator 100 of a fifth embodiment of the oil separating apparatus according to the present invention includes first tank 1″, a second tank 2″ disposed in the first tank 1″, and a barrier 30″ that is configured to be similar to that of the fourth embodiment. The second tank 2″ includes a plurality of threaded rods 24″ that are fixed to a bottom of the first tank 1″, and a tank body 23″ that defines the second space 21 therein, and that is movable along the threaded rods 24″ In this embodiment, the liquid-level control unit 50 is omitted, and the second tank 2″ is movable in a vertical direction to adjust the liquid level of the wastewater in the second tank 2″. Moreover, the liquid-level control unit 50 (see FIG. 2) of the first embodiment may be provided on the first tank 1″ to maintain the liquid level of the wastewater in the first tank 1″.

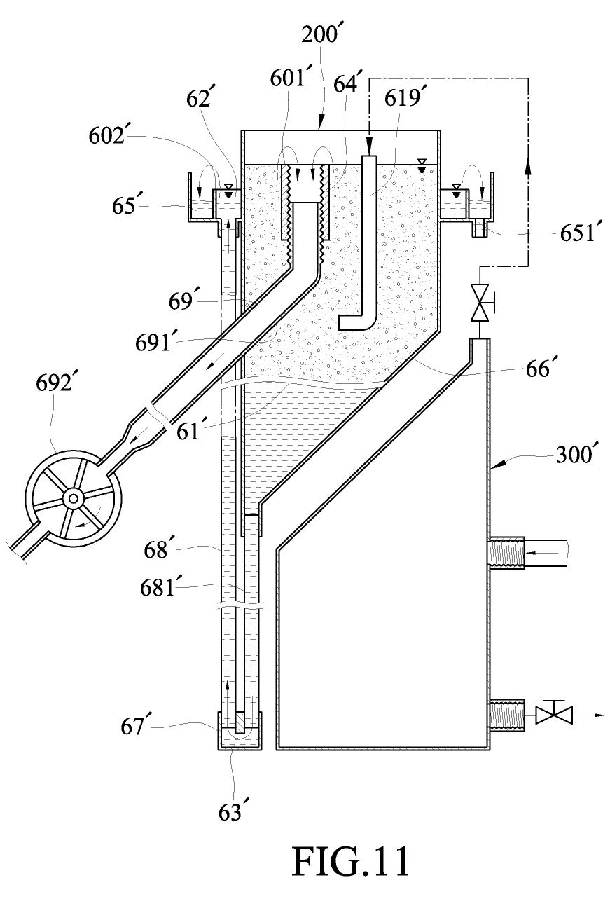

FIG. 11 illustrates the main separator 200′ and the auxiliary separator 300′ of a sixth embodiment of the oil separating apparatus according to the present invention. The auxiliary separator 300′ is similar to that of the first embodiment.

The main separator 200′ includes an upper body 66′, a lower body 67′, an extending tube 68′, a connecting tube 681′ and an oil exit tube 69′.

The upper body 66′ defines a main separating chamber 61′, a wastewater chamber 62′ extending around the main separating chamber 61′, a drain chamber 65′ extending around the wastewater chamber 62′, and a wastewater exit channel 651′ communicating fluidly with the drain chamber 65′. The upper body 66′ further has a second weir 602′ that is disposed between the wastewater chamber 62′ and the drain chamber 65′, and an inlet tube portion 619′ that communicates fluidly the main separating chamber 61′ and the auxiliary separator 300′.

The lower body 67′ defines a communicating channel 63′ therein. The extending tube 68′ interconnects the upper and lower bodies 66′, 67′, and communicates fluidly the wastewater chamber 62′ and the communicating channel 63′. The connecting tube 681′ is parallel to the extending tube 68′, interconnects the upper and lower bodies 66′, 67′, and communicates fluidly the main separating chamber 61′ and the communicating channel 63′.

The oil exit tube 69′ includes a tube portion 691′ that extends into the main separating chamber 61′, a sleeve member 64′ that is disposed in the main separating chamber 61′, and that is threaded drivingly to an upper portion of the tube portion 691′, and a vane pump 692′ that is connected to the tube portion 691′ for sealing tightly the tube portion 691′ when the oil separating apparatus is not at work. The sleeve member 64′ has an upper portion serving as a first weir 601′.

While the present invention has been described in connection with what are considered the most practical embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An oil separating apparatus comprising:
a preliminary separator adapted for collecting wastewater; and
a main separator having
a main separating chamber that communicates fluidly with said preliminary separator and that has an upper opening and a lower opening,
a wastewater exit channel, and
a communicating channel that communicates fluidly said wastewater exit channel and said lower opening of said main separating chamber, a distance between said upper and lower openings of said main separating chamber ranging from 300 millimeters to 3000 millimeters.

2. The oil separating apparatus as claimed in claim 1, wherein said preliminary separator has
a first space that is adapted to be filled with the wastewater,
a second space,
a barrier that spaces said first and second spaces, the wastewater flowing over an upper edge of said barrier and into said second space when the liquid level of the wastewater is higher than said upper edge of said barrier, and
a drawing unit that includes a driving device and a drawing device driven by said driving device, said drawing device including a suction inlet and a drain conduit, said suction inlet being located in said second space and lower than said upper edge of said barrier, said drain conduit being adapted to drain the wastewater out from said second space and communicating fluidly with said main separating chamber of said main separator.

3. The oil separating apparatus as claimed in claim 2, wherein said barrier is adjustable in height.

4. The oil separating apparatus as claimed in claim 3, wherein said barrier includes
a pair of spaced-apart vertical guide rails,
a sliding block that is disposed between and in contact with said guide rails and that is slidable along said guide rails, an upper portion of said sliding block serving as said upper edge of said barrier, and
a telescopic plate assembly that is connected to said sliding block and for spacing said first and second spaces.

5. The oil separating apparatus as claimed in claim 2, wherein said preliminary separator further includes a liquid-level control unit including
a liquid container that is disposed above said second space, and that is adapted to contain a liquid,
a liquid tube that communicates fluidly said second space and the liquid in an inner space of said liquid container and that has an end opening distal from said liquid container, and
a control tube that communicates fluidly said second space and a portion of said inner space of said liquid container located above the liquid, and that has an end opening distal from said liquid container, said end opening being higher than said suction inlet and said end opening of said liquid tube, and lower than said upper edge of said barrier, the liquid in said liquid container flowing into said second space when the liquid level of the wastewater in said second space is lower than said end opening of said control tube.

6. The oil separating apparatus as claimed in claim 1, wherein said main separator further has a wastewater chamber having
an upper opening that is lower than said upper opening of said main separating chamber and that communicates fluidly said wastewater exit channel, and
a lower opening that communicates fluidly said communicating channel.

7. The oil separating apparatus as claimed in claim 6, wherein said main separator further includes
an upright main tube that defines said main separating chamber therein, and that has an inlet tube portion, said inlet tube portion being located between said upper and lower openings of said separating chamber, and communicating fluidly said main separating chamber and said drain conduit of said drawing device,
a surrounding wall that surrounds an upper portion of said main tube and that cooperates with said upper portion of said main tube to define an oil chamber therebetween,
a first wall segment that extends around said surrounding wall, that cooperates with said surrounding wall to define said wastewater chamber therebetween, and that has an upper portion defining said upper opening of said wastewater chamber, said first wall segment extending in a circumferential direction by an angle of more than 180 degrees such that said wastewater chamber extends in the circumferential direction by an angle of more than 180 degrees, and
a second wall segment that extends around said first wall segment and that cooperates with said first wall segment to define a drain chamber therebetween, said second wall segment extending in the circumferential direction by an angle of more than 180 degrees, said drain chamber extending in the circumferential direction by an angle of more than 180 degrees.

8. The oil separating apparatus as claimed in claim 7, wherein said main tube of said main separator further includes main tube portion and a sleeve member that is threaded drivingly on an upper portion of said main tube portion and that defines said upper opening of said main separating chamber, said sleeve member and said upper portion of said main tube portion cooperatively serving as said upper portion of said main tube.

9. The oil separating apparatus as claimed in claim 8, wherein said main separator further includes
an upper body that has said surrounding wall, said first wall segment and said second wall segment,
a lower body that defines said communicating channel therein, and
an extending tube that is parallel to said main tube, that has opposite ends connected respectively to said upper and lower bodies, and that communicates fluidly said communicating channel and said wastewater chamber.

10. The oil separating apparatus as claimed in claim 2, further comprising an auxiliary separator including
a barrel that defines a separating space therein, and that has an inlet opening via which said drain conduit of said drawing device communicates fluidly said separating space,
a lower outlet tube that is connected to a lower end portion of said barrel, and
an upper outlet tube that is connected to an upper end portion of said barrel, and that communicates fluidly said main separating chamber and said separating space, said inlet opening being located between said lower and upper outlet tubes.
